(19) United States
(12) Patent Application Publication
(10) Pub. No.: US 2017/0332658 A1
(43) Pub. Date: Nov. 23, 2017

(54) Refrigerator Appliance and Frozen Beverage Unit

(71) Applicant: General Electric Company, Schenectady, NY (US)

(72) Inventors: Alan Joseph Mitchell, Louisville, KY (US); Robert Lee Lewis, Jr., Louisville, KY (US)

(21) Appl. No.: 15/158,657

(22) Filed: May 19, 2016

(51) Int. Cl. A23G 9/04; A23G 9/22

(52) U.S. Cl. CPC A23G 9/045; A23G 9/228; A23G 9/222; A23G 9/224

(57) ABSTRACT

A refrigerator appliance is provided and may include a cabinet, a door, a sealed cooling system, an ice crusher motor, and a frozen beverage unit. The cabinet may define a chilled chamber. The door may be attached to the cabinet to selectively restrict access to the chilled chamber. The door may include a door liner defining an icebox compartment. The sealed cooling system may be in fluid communication with the icebox compartment to circulate air within the refrigerator appliance. The ice crusher motor may be mounted within the icebox compartment. The frozen beverage unit may include a freezing tank and a rotatable auger. The rotatable auger may extend into the freezing tank and in operable attachment with the ice crusher motor.

### FIELD OF THE INVENTION

The present subject matter relates generally refrigerator appliances, and more particularly to refrigerator appliances including features for frozen beverages.

### BACKGROUND OF THE INVENTION

Certain refrigerator appliances utilize sealed systems for cooling chilled chambers of the refrigerator appliances. A typical sealed system includes an evaporator and a fan, the fan generating a flow of air across the evaporator and cooling the flow of air. The cooled air is then provided through an opening into the chilled chamber to maintain the chilled chamber at a desired temperature. Air from the chilled chamber is circulated back through a return duct to be re-cooled by the sealed system during operation of the refrigerator appliance, maintaining the chilled chamber at the desired temperature. An ice making device is often provided and disposed within the chilled chamber.

Separate from a refrigerator, appliances exist for making various popular frozen beverages (e.g., margaritas, daiquiris, slush, etc.). Such appliances often include a tank and a rotating auger. A series of heat exchange pipes may be also be included to directly contact the tank. Heat exchange between the pipes and the tank may significantly reduce the temperature therein. One or more liquid ingredients may be provided within the tank. During use, the ingredients may be mixed and at least partially frozen until a desired temperature or consistency is reached.

Many existing frozen beverage appliances are limited to large-scale or commercial uses. Due to the specialized nature of such appliances, they have failed to gain widespread adoption for consumer or home use. Many consumers only desire frozen beverages during select occasions, so sacrificing money and or space for an independent appliance may be undesirable. Moreover, existing consumer-level appliances for making frozen beverages are often exceedingly bulky and/or expensive. Such appliances are often provided with relatively low-capacity cooling systems, making them unable to provide satisfactory performance.

Accordingly, an unobtrusive appliance for making and storing frozen beverages would be useful. It would be advantageous if such an appliance was incorporated within a refrigerator appliance without sacrificing storage or beverage consistency. More particularly, it would be useful to provide a refrigerator appliance with a selectively removable unit for making and storing frozen beverages.

### BRIEF DESCRIPTION OF THE INVENTION

Aspects and advantages of the invention will be set forth in part in the following description, or may be obvious from the description, or may be learned through practice of the invention.

In one aspect of the present disclosure a refrigerator appliance is provided. The refrigerator appliance may include a cabinet, a door, a sealed cooling system, an ice crusher motor, and a frozen beverage unit. The cabinet may define a chilled chamber. The door may be attached to the cabinet to selectively restrict access to the chilled chamber. The door may include a door liner defining an icebox compartment. The sealed cooling system may be in fluid communication with the icebox compartment to circulate air within the refrigerator appliance. The ice crusher motor may be mounted within the icebox compartment. The frozen beverage unit may include a freezing tank and a rotatable auger. The rotatable auger may extend into the freezing tank and in operable attachment with the ice crusher motor.

In another aspect of the present disclosure, a method of operating a refrigerator appliance is provided. The appliance may include a cabinet and a door attached to the cabinet. The appliance may define an icebox compartment and further include an icemaker and an ice crusher motor mounted within the icebox compartment. The method may include detecting a frozen beverage unit including a freezing tank and a rotatable auger in operable attachment with the ice crusher motor. The method may also include preventing icemaker operation based on detection of the frozen beverage unit. The method may further include activating the ice crusher motor to rotate the auger based on detection of the frozen beverage unit.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a refrigerator appliance according to an exemplary embodiment of the present disclosure.

FIG. 2 provides a perspective view of the exemplary refrigerator appliance shown in FIG. 1, wherein a refrigerator door is in an open position according to an exemplary embodiment of the present disclosure.

FIG. 3 provides a schematic view of a sealed cooling system of the exemplary refrigerator appliance shown in FIG. 1.

FIG. 4 provides a side view of an icebox compartment of a refrigerator appliance having a removable ice dispenser unit according to an exemplary embodiment of the present disclosure.

FIG. 5 provides a side view of an icebox compartment of a refrigerator appliance having a removable frozen beverage unit according to an exemplary embodiment of the present disclosure.

FIG. 6 provides a front view of the exemplary icebox and frozen beverage unit of FIG. 5.

FIG. 7 provides a side view of an icebox of a refrigerator appliance having a removable frozen beverage unit according to another exemplary embodiment of the present disclosure.

FIG. 8 provides a front view of the exemplary icebox and frozen beverage unit of FIG. 7.

FIG. 9 provides a flow chart illustrating a method of operating a refrigerator appliance in accordance with an exemplary embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In some aspects of the present disclosure, a refrigerator appliance is provided and includes a removable frozen beverage unit. Generally, the frozen beverage unit may be selectively installed or uninstalled by a user. For example, an ice dispenser unit within a door of the refrigerator may be swapped for the frozen beverage unit as needed. A motor that drives the ice dispenser unit may be used to drive the frozen beverage unit, advantageously reducing the complexity of installation and the number of different parts to be swapped.

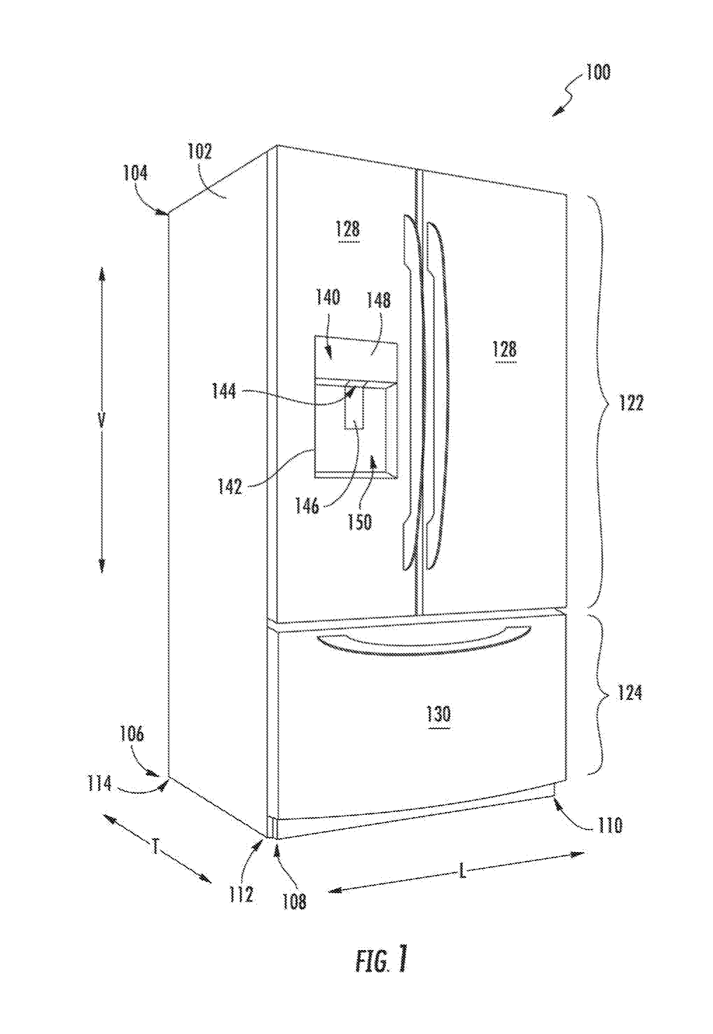

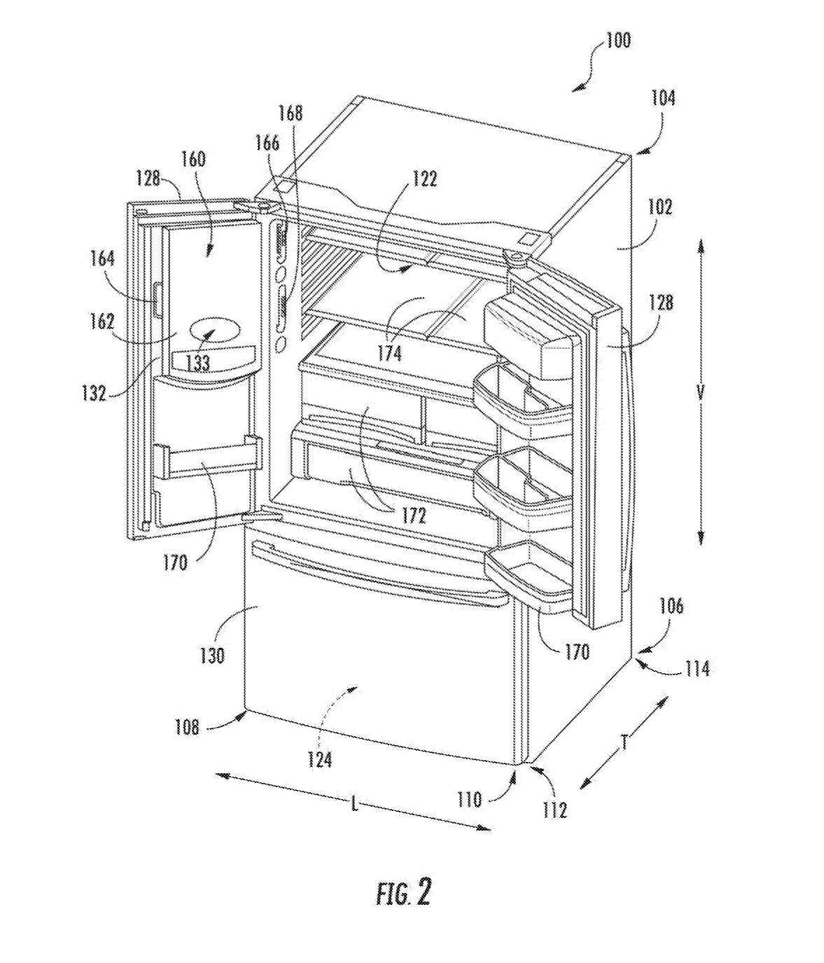

Turning to the figures, FIGS. 1 and 2 illustrate a perspective view of a refrigerator 100. Refrigerator appliance 100 includes a cabinet or housing 102 that extends between a top 104 and a bottom 106 along a vertical direction V, between a first side 108 and a second side 110 along a lateral direction L, and between a front side 112 and a rear side 114 along a transverse direction T. Each of the vertical direction V, lateral direction L, and transverse direction T are mutually perpendicular to one another.

Housing 102 defines chilled chambers for receipt of food items for storage. In particular, housing 102 defines fresh food chamber 122 positioned at or adjacent top 104 of housing 102 and a freezer chamber 124 arranged at or adjacent bottom 106 of housing 102. As such, refrigerator appliance 100 is generally referred to as a bottom mount refrigerator. It is recognized, however, that the benefits of the present disclosure apply to other types and styles of refrigerator appliances such as, e.g., a top mount refrigerator appliance or a side-by-side style refrigerator appliance. Consequently, the description set forth herein is for illustrative purposes only and is not intended to be limiting in any aspect to any particular refrigerator chamber configuration.

According to the illustrated embodiment, various storage components are mounted within fresh food chamber 122 to facilitate storage of food items therein as will be understood by those skilled in the art. In particular, the storage components include bins 170, drawers 172, and shelves 174 that are mounted within fresh food chamber 122. Bins 170, drawers 172, and shelves 174 are positioned to receive of food items (e.g., beverages and/or solid food items) and may assist with organizing such food items. As an example, drawers 172 can receive fresh food items (e.g., vegetables, fruits, and/or cheeses) and increase the useful life of such fresh food items.

Refrigerator doors 128 are rotatably hinged to an edge of housing 102 for selectively accessing fresh food chamber 122. In addition, a freezer door 130 is arranged below refrigerator doors 128 for selectively accessing freezer chamber 124. Freezer door 130 is coupled to a freezer drawer (not shown) slidably mounted within freezer chamber 124. Refrigerator doors 128 and freezer door 130 are shown in the closed configuration in FIG. 1.

Refrigerator appliance 100 also includes a delivery assembly 140 for delivering or dispensing liquid water and/or ice. Delivery assembly 140 includes a dispenser 142 positioned on or mounted to an exterior portion of refrigerator appliance 100, e.g., on one of refrigerator doors 128. Dispenser 142 includes a discharging outlet 144 for accessing ice and liquid water. An actuating mechanism 146, shown as a paddle, is mounted below discharging outlet 144 for operating dispenser 142. In alternative exemplary embodiments, any suitable actuating mechanism may be used to operate dispenser 142. For example, dispenser 142 can include a sensor (such as an ultrasonic sensor) or a button rather than the paddle. A control panel 148 is provided for controlling the mode of operation. For example, control panel 148 includes a plurality of user inputs (not labeled), such as a water dispensing button and an ice-dispensing button, for selecting a desired mode of operation such as crushed or non-crushed ice.

Discharging outlet 144 and actuating mechanism 146 are an external part of dispenser 142 and are mounted in a dispenser recess 150. Dispenser recess 150 is positioned at a predetermined elevation convenient for a user to access ice or water and enabling the user to access ice without the need to bend-over and without the need to open refrigerator doors 128. In the exemplary embodiment, dispenser recess 150 is positioned at a level that approximates the chest level of a user. As described in more detail below, the dispensing assembly 140 may receive ice from an icemaker disposed in a sub-compartment of the fresh food chamber 122.

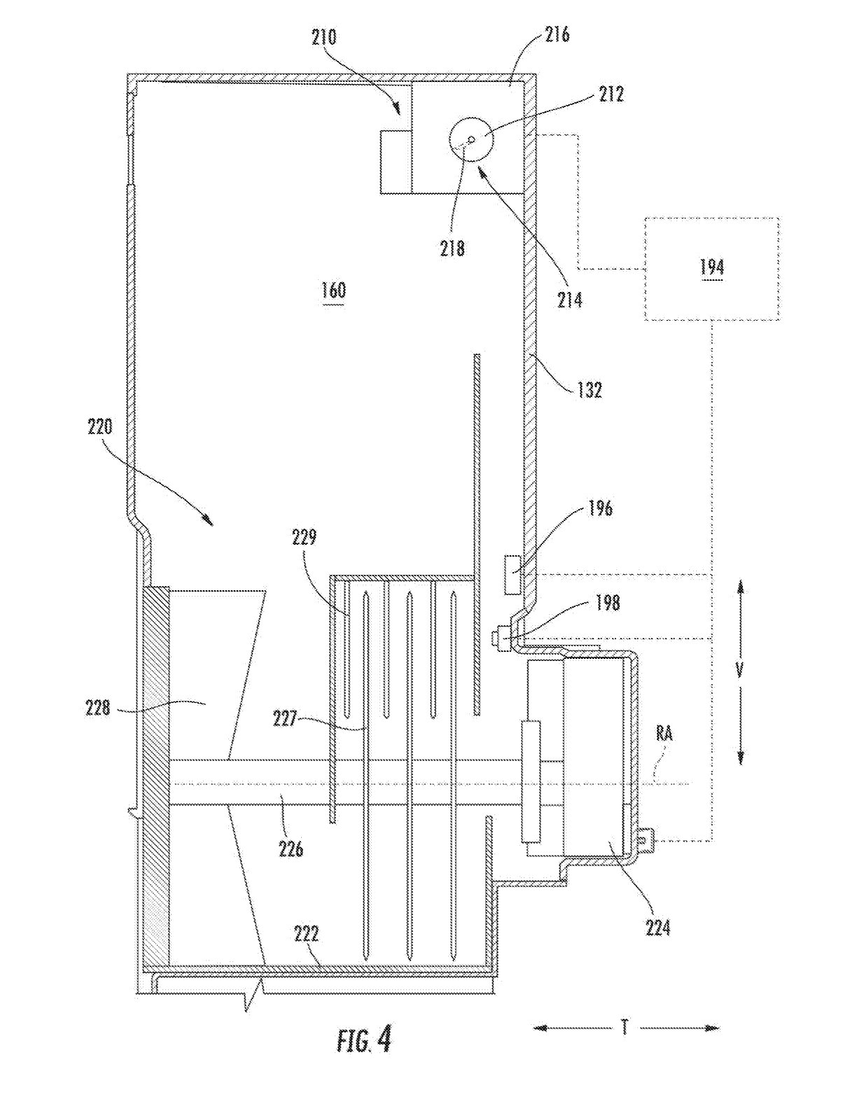

FIG. 2 provides a perspective view of a door of refrigerator appliance 100 shown with refrigerator doors 128 in the open position. As shown, at least one door 128 includes a door liner 132 defining a sub-compartment, e.g., icebox compartment 160. Icebox compartment 160 extends into fresh food chamber 122 when refrigerator door 128 is in the closed position. Although icebox compartment 160 is shown in door 128, additional or alternative embodiments may include an icebox compartment defined within door 130. As discussed in greater detail below, an ice making assembly or icemaker 210 may be positioned or disposed within icebox compartment 160. In optional embodiments, an ice dispenser unit 220 (see FIG. 4) may also be selectively positioned within icebox compartment 160. Thus, ice may be supplied to dispenser recess 150 (see FIG. 1) from the icemaker 210 and/or ice dispenser unit 220 in icebox compartment 160 on a back side of refrigerator door 128.

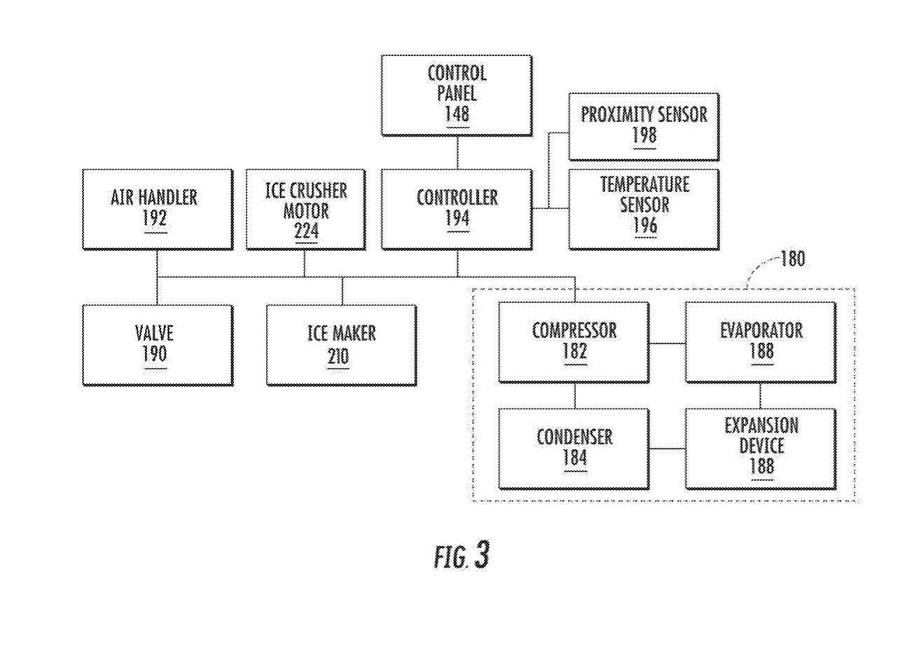

An access door—e.g., icebox door 162—may be hinged to icebox compartment 160 to selectively cover or permit access to opening of icebox compartment 160. Icebox door 162 permits selective access to icebox compartment 160. Any manner of suitable latch 164 is provided with icebox compartment 160 to maintain icebox door 162 in a closed position. As an example, latch 164 may be actuated by a consumer in order to open icebox door 162 for providing access into icebox compartment 160. Icebox door 162 can also assist with insulating icebox compartment 160, e.g., by thermally isolating or insulating icebox compartment 160 from fresh food chamber 122. As described in detail below, this thermal insulation helps maintain icebox compartment 160 at a temperature below the freezing point of water. In addition icebox compartment 160 may receive cooling air from a chilled air supply duct 166 and a chilled air return duct 168 disposed on a side portion of housing 102 of refrigerator appliance 100. In this manner, the supply duct 166 and return duct 168 may recirculate chilled air from a suitable sealed cooling system 180 (see FIG. 3) through icebox compartment 160.

FIG. 3 provides a schematic view of certain components of refrigerator appliance 100. As may be seen in FIG. 3, refrigerator appliance 100 includes a sealed cooling system 180 for executing a vapor compression cycle for cooling air within refrigerator appliance 100, e.g., within fresh food chamber 122 and freezer chamber 124. Sealed cooling system 180 includes a compressor 182, a condenser 184, an expansion device 186, and an evaporator 188 connected in fluid series and charged with a refrigerant. As will be understood by those skilled in the art, sealed cooling system 180 may include additional components, e.g., at least one additional evaporator, compressor, expansion device, and/or condenser. As an example, sealed cooling system 180 may include two evaporators.

Within sealed cooling system 180, gaseous refrigerant flows into compressor 182, which operates to increase the pressure of the refrigerant. This compression of the refrigerant raises its temperature, which is lowered by passing the gaseous refrigerant through condenser 184. Within condenser 184, heat exchange with ambient air takes place so as to cool the refrigerant and cause the refrigerant to condense to a liquid state.

Expansion device (e.g., a valve, capillary tube, or other restriction device) 186 receives liquid refrigerant from condenser 184. From expansion device 186, the liquid refrigerant enters evaporator 188. Upon exiting expansion device 186 and entering evaporator 188, the liquid refrigerant drops in pressure and vaporizes. Due to the pressure drop and phase change of the refrigerant, evaporator 188 is cool relative to fresh food and freezer chambers 122 and 124 of refrigerator appliance 100. As such, cooled air is produced and refrigerates fresh food and freezer chambers 122 and 124 of refrigerator appliance 100. Thus, evaporator 188 is a heat exchanger which transfers heat from air passing over evaporator 188 to refrigerant flowing through evaporator 188.

Optionally, refrigerator appliance 100 further includes a valve 190 for regulating a flow of liquid water to icemaker 210. Valve 190 is selectively adjustable between an open configuration and a closed configuration. In the open configuration, valve 190 permits a flow of liquid water to icemaker 210. Conversely, in the closed configuration, valve 190 hinders the flow of liquid water to icemaker 210.

Refrigerator appliance 100 also includes an air handler 192. Air handler 192 is operable to urge a flow of chilled air from freezer chamber 124 into icebox compartment 160, e.g., via supply and return ducts 166, 168 and chilled air passages 266, 268, as discussed below. Air handler 192 can be positioned within supply and return ducts 166, 168 of sealed cooling system 180 and be any suitable device for moving air. For example, air handler 192 can be an axial fan or a centrifugal fan.

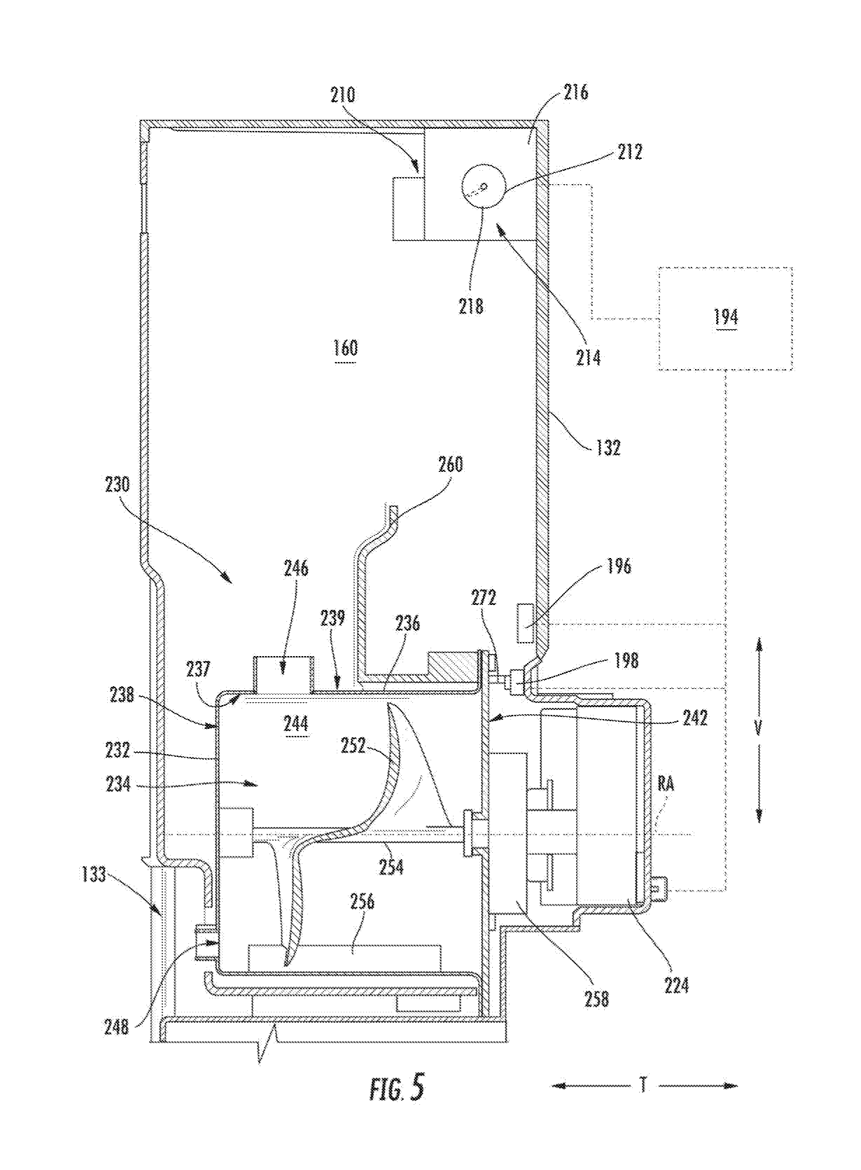

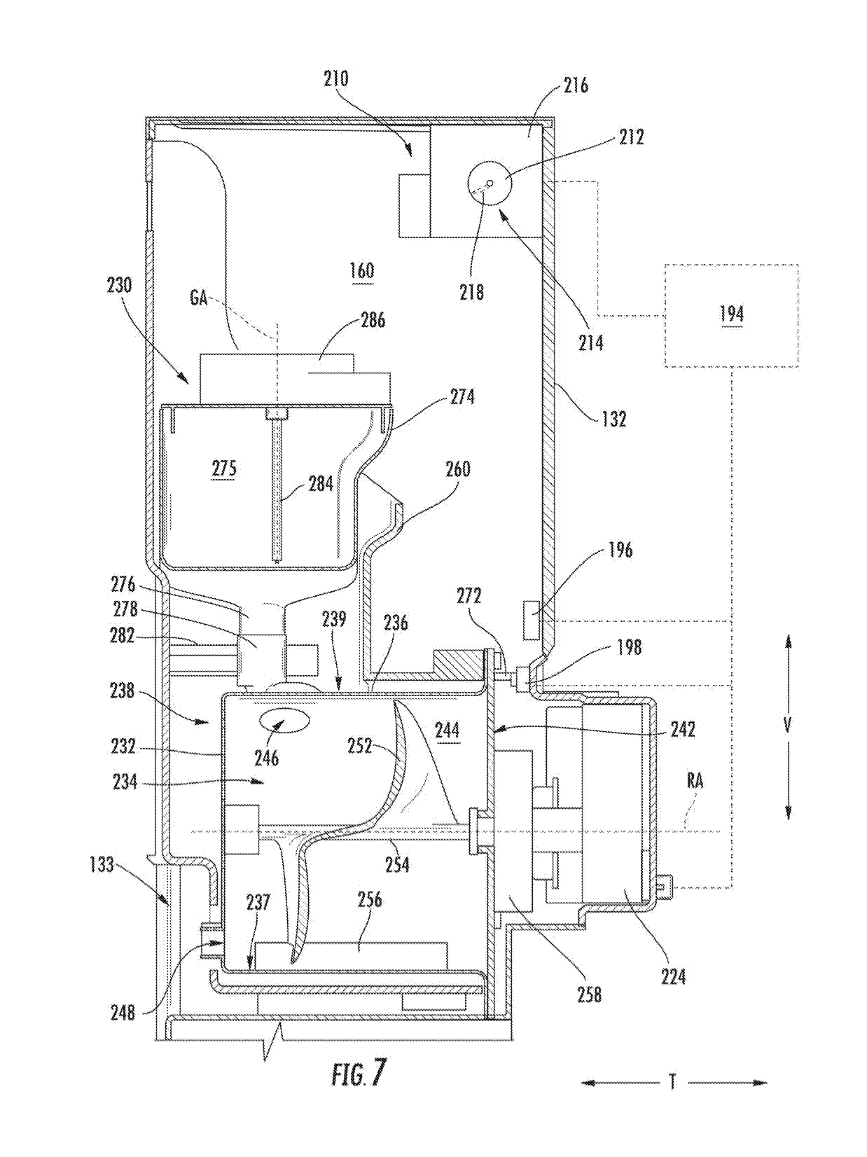

In some embodiments, refrigerator appliance 100 further includes an ice crusher motor 224 mounted within icebox compartment 160, e.g., fixed to door liner 132. For example, ice crusher motor 224 may be a suitable electrical or hydraulic motor. One or more assembly units, such as an ice dispenser unit 220 (see FIG. 4) and/or frozen beverage unit 230 (see FIGS. 5 and 7), may be removably connected or attached to ice crusher motor 224. When one assembly unit 220, 230 is mounted within icebox compartment 160 and attached to ice crusher motor 224, ice crusher motor 224 may selectively drive or rotate a portion of the respective assembly 220, 230.

Refrigerator appliance 100 further includes a controller 194. Operation of the refrigerator appliance 100 is regulated by controller 194 that is operatively coupled to control panel 148. In one exemplary embodiment, control panel 148 may represent a general purpose I/O (“GPIO”) device or functional block. In another exemplary embodiment, control panel 148 may include input components, such as one or more of a variety of electrical, mechanical or electro-mechanical input devices including rotary dials, push buttons, touch pads, and touch screens. Control panel 148 may be operably connected in communication with controller 194 via one or more signal lines or shared communication busses. Control panel 148 provides selections for user manipulation of the operation of refrigerator appliance 100. In response to user manipulation of the control panel 148, controller 194 operates various components of refrigerator appliance 100. For example, controller 194 is operatively connected or in communication with compressor 182, valve 190, ice crusher motor 224, and air handler 192, such that controller 194 can operate such components.

Controller 194 may also be operably connected in communication with a variety of sensors, such as a temperature sensor 196 and/or proximity sensor 198. As will be described below, controller 194 may receive signals from temperature sensor 196 that correspond to a temperature of an atmosphere or ambient air within, e.g., icebox compartment 160. Controller 194 may additionally or alternatively receive signals from proximity sensor 198 that correspond to a presence of a predetermined assembly within, e.g., icebox compartment 160.

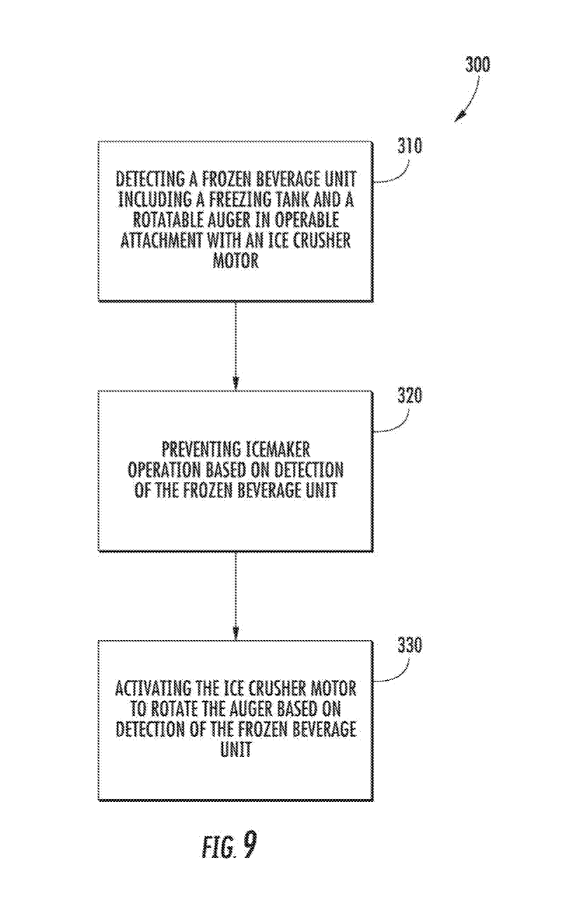

Controller 194 includes memory and one or more processing devices such as microprocessors, CPUs or the like, such as general or special purpose microprocessors operable to execute programming instructions or micro-control code associated with operation of refrigerator appliance 100. The memory can represent random access memory such as DRAM, or read only memory such as ROM or FLASH. The processor executes programming instructions stored in the memory. For certain embodiments, the instructions include a software package configured to operate appliance 100 and, e.g., execute the exemplary method 300 described below with reference to FIG. 9. The memory can be a separate component from the processor or can be included onboard within the processor. Alternatively, controller 194 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Turning to FIGS. 4 through 8, exemplary embodiments of icebox compartment 160 are illustrated. It is understood that FIGS. 4 through 8 illustrate icebox compartment 160 when a corresponding door 128 (see FIG. 2) is in the closed position, as shown in FIG. 1. Any described directions, such as the vertical direction V, lateral direction L, and transverse direction T, will correspond to that same configuration, unless otherwise indicated.

As shown in FIG. 4, some embodiments include an icemaker 210 that is disposed within icebox compartment 160. Generally, icemaker 210 is operable to form ice and may be readily attached to icebox compartment 160 using, for example, clips, fasteners, or other securing means. Icemaker 210 may include a mold body 212 for receipt of water for freezing. In particular, mold body 212 may receive liquid water and such liquid can freeze therein and form ice cubes. Icemaker 210 can harvest such ice cubes and direct such ice cubes to ice dispenser unit 230. In some embodiments, icemaker 210 includes a rotatable ice ejector 214. As shown, ejector 214 includes an ejector motor 216 operably attached to one or more ejector arms 218. When activated, ejector motor 216 motivates, e.g., rotates, ejector arm 218 through icemaker 210 to remove ice cubes once formed within icemaker 210.

In exemplary embodiments, ice dispenser unit 220, including an ice bin 222, may be positioned below icemaker 210, e.g., in the vertical direction V, within icebox compartment 160. Generally, ice dispenser unit 220 is selectively crushes or propelling ice being delivered from icemaker 210, e.g., via a rotatable drive rod 226 positioned through ice bin 222. Moreover, ice dispenser unit 220 may selectively attach to door 128 (see FIG. 2). In some embodiments, ice dispenser unit 220 is removably mounted within icebox compartment 160. For example, ice dispenser unit 220 may rest on a portion of door liner 132 and selectively slide in or out of icebox compartment through the opening otherwise covered by icebox door 162 (see FIG. 2). A user may thus mount or remove ice dispenser unit 220 as desired.

As shown, ice crusher motor 224 may be mounted within icebox compartment 160 below icemaker 210, e.g., in the vertical direction V. Mounting ice dispenser unit 220 within icebox compartment 160 may form an operable mechanical connection with drive unit 230 and ice crusher motor 224. Optionally, clips, fasteners, or other securing means may be provided to further secure ice dispenser unit 220 to door liner 132.

In some embodiments, a plurality of ice crusher blades 227, 229 are positioned within ice bin 222. For instance, multiple ice crusher blades 227, 229 may be positioned on or around drive rod 226. In optional embodiments, the plurality of blades 227, 229 includes at least one rotary blade 227 and at least one fixed blade 229. If multiple rotary blades 227 are provided, the rotary blades 227 may be distributed on a rotation axis RA and/or rod 226 such that the rotary blades 227 are staggered along the rod 226. When mounted within icebox compartment 160, the rotary blades 227 are operably attached to an ice crusher motor 224. The stationary blade(s) may be staggered or positioned between rotary blades 227. During use, a single rotary blade 227 may thus crush ice against the stationary blade(s) 229 as ice passes through the bin 222.

In exemplary embodiments, a rotatable ice paddle 228 may be operably attached to drive rod 226 to guide or move ice through icebox compartment 160. The plurality of blades 227, 229 and the rotatable ice paddle 228 may rotate about drive rod 226, in unison, such that the rotary blades 227 and ice paddle 228 rotate at about the same angular velocity. As shown, ice crusher motor 224 is operably attached to drive rod 226. Rotation of ice crusher motor 224, and thus plurality of blades 227 and/or ice paddle 228, may generally be controlled by controller 194. For instance, upon receiving input from control panel 148 (see FIG. 1), controller 194 may initiate temporary activation of ice crusher motor 224. Activation of ice crusher motor 224 may, in turn, motivate rotation of drive rod 226, as well as blades 227 and/or paddle 228 operably attached thereto.

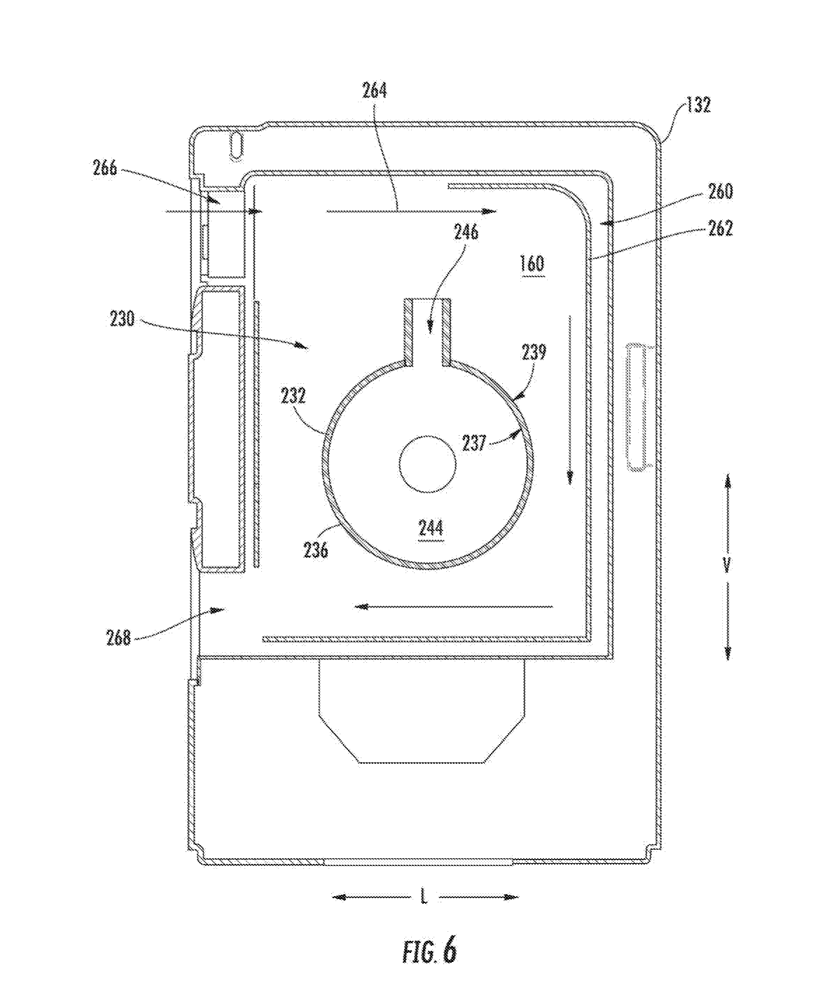

As shown in FIGS. 5 and 6, some embodiments include a frozen beverage unit 230 that is disposed within icebox compartment 160. Frozen beverage unit 230 may be removably mounted within icebox compartment 160 and removably connected or attached to ice crusher motor 224. For example, frozen beverage unit 230 may rest on a portion of door liner 132 and selectively slide in or out of icebox compartment 160 through the opening otherwise covered by icebox door 162 (see FIG. 2). A user may thus mount or remove frozen beverage unit 230 as desired. In some embodiments, frozen beverage unit 230 selectively replaces or is exchanged for ice dispenser unit 220 (see FIG. 4). Mounting frozen beverage unit 230 within icebox compartment 160 may form an operable mechanical connection a drive rod 254 and ice crusher motor 224. Optionally, clips, fasteners, or other securing means may be provided to further secure frozen beverage unit 230 to door liner 132.

Generally, frozen beverage unit 230 is operable to mix, freeze, and/or maintain a frozen beverage mixture at a partially-frozen or otherwise desired state. Frozen beverage unit 230 may include a freezing tank 232 and a rotatable auger 234. In some embodiments, freezing tank 232 may include one or more sidewalls 236, 238, 242 having an outer surface 237 and an inner surface 239 that define, and at least partially surround, an enclosed volume 244. For instance, some embodiments of freezing tank 232 include cylindrical sidewall 236 that extends in the transverse direction T through the icebox compartment 160 when mounted. As shown, cylindrical sidewall 236 is bounded by a forward sidewall 238 at one end (e.g., one transverse extreme) and a rear sidewall 242 at an opposite end (e.g., an opposite transverse extreme). Although freezing tank 232 is illustrated as roughly parallel to the transverse direction T, some embodiments will define a non-parallel angle relative to the transverse direction T, e.g., at cylindrical sidewall 236. The negative angle may further guide a frozen beverage toward forward sidewall, e.g., during dispensing operations. Exemplary embodiments of cylindrical sidewall 236 define a negative angle between (−0°) and (−10°) relative to the transverse direction T from the rear sidewall 242 to the forward sidewall 238. Optionally, the negative angle may be (−3°).

A liquid inlet 246 may be defined through freezing tank 232, for instance, through cylindrical sidewall 236 at a location above enclosed volume 244. Liquid inlet 246 may receive one or more liquid ingredient of a frozen beverage mixture. In additional or alternative embodiments, a beverage outlet 248 is defined through freezing tank 232, such as, through a bottom portion of forward sidewall 238 to fluidly communicate with enclosed volume 244. Optionally, beverage outlet 248 may be selectively blocked by a removable plug or fluid tap (not pictured) to selectively restrict or allow the frozen beverage mixture to be directed out of freezing tank 232. In some embodiments, a dispenser outlet 133 is defined through liner to permit access and/or dispensing of frozen beverage mixture while freezing tank 232 remains within icebox compartment 160. Removable plug or fluid tap may thus be inserted or disposed through liner 132 and/or into beverage outlet 248. Optionally, a sliding shutter may additionally be provided at dispenser outlet 133 to selectively close or block dispenser outlet, e.g., when freezing tank 232 is removed from icebox compartment 160.

As shown, rotatable auger 234 may extend into freezing tank 232, for instance, into enclosed volume 244 between forward sidewall 238 and rear sidewall 242. Optionally, rotatable auger 234 may include one or more helical blades 252 formed as a helicoid having a plurality of passes about a drive rod 254 defining a rotation axis RA. As shown, drive rod 254 may extend from forward sidewall 238 to rear sidewall 242 along the transverse direction T. Drive rod 254 may also extend through rear sidewall 242 to operably attach to icemaker 224. Auger 234 is operable to rotate within freezing tank 232 about a drive rod 254 and/or rotation axis RA. A low-friction bearing, such as a Polytetrafluoroethylene (PTFE) bearing may be engage drive rod 254, e.g., at forward sidewall 238. Optionally, auger 234 may include one or a radial scoop 256 extending in a direction parallel to the rotation axis RA across the plurality of radial passes. When frozen beverage unit 230 is mounted within icebox compartment 160, rotatable auger 234 may operably attach to ice crusher motor 224, e.g., via drive rod 254. In turn, activation of ice crusher motor 224 may force auger 234 to rotate within freezing tank 232.

In some embodiments, a gearbox 258 is provided in operable attachment with auger 234 and ice crusher motor 224. Gearbox 258 may be mounted to freezing tank 232, e.g., at the rear sidewall 242, to join auger 234 to motor 224. Optionally, gearbox 258 may be fixed to rear sidewall 242 between rear sidewall 242 and motor 224. Generally, gearbox 258 is modifies, e.g., increases or decreases, the speed of rotation output by ice crusher motor 224. The modified speed may be tuned according to a desired rotation speed of auger 234. As an example, in some embodiments, ice crusher motor 224 is operable to output a rotation speed of 22 rotations per minute (RPM). Gearbox 258 increases rotation speed output to rotatable auger 234, e.g., at drive rod 254, to 50 RPM. During operation of frozen beverage unit 230, auger 234 may, thus, rotate at 50 RPM.

In some embodiments, frozen beverage unit 230 includes an air circulation housing 260 having one or more housing walls 262. As shown, housing walls 262 at least partially enclose freezing tank 232. Moreover, air circulation housing 260, including walls 262, defines an air flow path (illustrated at arrows 264) about the outer surface 239 of the freezing tank 232. During operation, chilled air may be selectively provided along the air flow path 264 to promote an even or consistent heat transfer from the frozen beverage mixture, e.g., via freezing tank 232. For instance, chilled air may be directed along air flow path 264 above liquid inlet 246 before continuing about a portion of cylindrical sidewall 236.

In some embodiments, air circulation housing 260 defines a chilled air inlet 266 and a chilled air outlet 268 that direct air into and out of air circulation housing 260, respectively. As shown, when frozen beverage unit 230 is mounted within icebox compartment 160, chilled air inlet 266 is in fluid communication with chilled air supply duct 166 (see FIG. 2). Chilled air inlet 266 is positioned downstream from chilled air supply duct and upstream from a remainder of air circulation housing 260. In some such embodiments, chilled air outlet 268 is in fluid communication with chilled air return duct 168. Chilled air outlet 268 is positioned upstream from chilled air return duct 168 and downstream from a remainder of air circulation housing 260. During use, chilled air may be selectively supplied to chilled air inlet 266 before flowing along air flow path 264 and through chilled air outlet 268.

In optional embodiments, a proximity sensor 198 is provided within icebox compartment 160. Generally, proximity sensor 198 is operable to detect the presence of one or more assemblies, e.g., frozen beverage unit 230. Proximity sensor 198 may transmit a corresponding signal when a frozen beverage unit 230 is positioned within icebox compartment 160. In some embodiments, proximity sensor 198 is mounted to icebox compartment 160 at a rear wall of liner 132. When frozen beverage unit 230 is placed within icebox compartment 160, proximity sensor 198 may be engaged such that a corresponding detection signal is transmitted to controller 194. Optionally, proximity sensor 198 may be formed as a pressure-sensitive contact sensor. Frozen beverage unit 230 may include a prong 272 extending outward from freezing tank 232. In exemplary embodiments, prong 272 extends from rear sidewall 242, e.g., in the transverse direction T, to engage proximity sensor 198 when mounted. Prong 272 is generally aligned on rear sidewall 242 to directly contact and depress proximity sensor 198. The proximity sensor 198 may transmit a detection signal in response to such contact. Although a contact sensor is described, it should be noted that additional or alternative embodiments may include another suitable proximity sensor, such as a capacitive sensor, radio frequency sensor (e.g., RFID sensor), infrared sensor, magnetic sensor, etc.

As referenced above, controller 194 may be operably connected to ice crusher motor 224. In some embodiments, controller 194 is configured to control operation of ice crusher motor 224 according to one or more predetermined frozen beverage mode. For instance, controller 194 may be configured to initiate a frozen beverage mode based on one or more inputs or signals received from control panel 148 (see FIG. 1) and/or proximity sensor 198. Multiple discrete frozen beverage modes may be provided for certain corresponding or operational factors (e.g., reducing energy use). Optionally, specific frozen beverage modes may be selected via user input, e.g., at control panel 148. According to the frozen beverage mode, controller 194 may subsequently activate or adjust one or more other components of refrigerator appliance 100. Other components, such as icemaker 210 may be prevented from operating, such as by halting signals thereto.

In some embodiments, initiating a frozen beverage mode includes activating ice crusher motor 224 to rotate auger 234. In response to initiating the frozen beverage mode, controller 194 may be configured to activate ice crusher motor 224 for a predetermined time period or open-ended time period.

In certain exemplary embodiment wherein controller 194 is configured to activate ice crusher motor 224 in response to input from actuating mechanism 146 and/or control panel 148 (see FIG. 1), controller 194 may be configured to disregard or override select input signals from actuating mechanism 146 (see FIG. 1) when in the frozen beverage mode. Activation of ice crusher motor 224 may be selectively decoupled from certain inputs or instructions at actuating mechanism 146 or control panel 148 when ice dispenser unit 220 is mounted within icebox compartment 160.

In additional or alternative embodiments, initiating the predetermined frozen beverage mode includes activating rotation of air handler 192 and/or compressor 182 (see FIG. 3). Air handler 192 may be activated to rotate or motivate chilled air through icebox compartment 160. Activation or operation of air handler 192 may be for continuous operation or operation may be limited to a predetermined time period. Moreover, activation or operation of air handler 192 may be further based upon one or more monitored conditions, e.g., temperature within icebox compartment 160, temperature at freezing tank 232, rotation speed of auger 234, etc. Advantageously, frozen beverages may be prepared or maintained with minimal user effort. In some such embodiments, a determination of desired air flow is made by controller 194. Controller 194 may receive a monitored signal, such as a temperature signal or a speed signal, from a sensor, e.g., temperature sensor 196 or proximity sensor 198. Once the monitored signal is received, controller 194 may adjust activation of air handler 192 accordingly.

Additionally or alternatively, compressor 182 may be activated to motivate refrigerant through sealed cooling system 180 and cool air directed to air handler 192. Activation or operation of compressor 182 may be for continuous operation or operation may be limited to a predetermined time period. Activation or operation of compressor 182 may be concurrent with or separate from activation of air handler 192. Moreover, activation or operation of compressor 182 may be further based upon one or more monitored conditions, e.g., temperature within icebox compartment 160, temperature at freezing tank 232, rotation speed of auger 234, etc.

In optional exemplary embodiment, controller 194 includes a predetermined range or threshold for rotation of auger 234. Activation or speed of the air handler 192 is at least partially based on the rotating speed of auger 234. Controller 194 is configured to receive a speed signal from ice crusher motor 224. According to the received speed signal, controller 194 is configured to determine a contemporary rotating speed. A contemporary rotating speed of auger 234 that is above the predetermined range or threshold may be indicative of a beverage consistency that is inadequately frozen. A contemporary rotating speed of auger 234 that is below the predetermined range or threshold may be indicative of a beverage consistency that is excessively frozen or has reached a desired state or consistency. Based upon the determined contemporary rotating speed, rotation of air handler 192 (see FIG. 3) may be increased, decreased, or maintained. Compressor 182 (see FIG. 3) may be additionally or alternatively activated. Optionally, a new target speed for air handler 192 may be selected by controller 194 before being transmitted to air handler 192. The target speed may be determined according to, e.g., a predetermined look-up table, formula, or model.

According to the contemporary rotating speed of auger 234, a visual and/or audio alert may be initiated, e.g., at control panel 148. For instance, controller 194 may be configured to determine or approximate the current state of beverage consistency. Determination may be made by reading or comparing the contemporary rotating speed of auger 234. Contemporary rotating speed may be matched to a corresponding set point provided by, e.g., a predetermined look-up table, formula, or model. The visual and/or audio alert may include any suitable indication alert, such as an illuminated light, a predetermined noise projected from a speaker, or a message presented on an electronic display. As an example, controller 194 may initiate an alert via an alert signal transmitted to an illuminated LED on control panel 148. The signal transmission may occur once controller 194 has determined a desired beverage consistency has been reached according to the contemporary rotating speed of auger 234.

In still further exemplary embodiment, controller 194 includes a predetermined range or threshold for temperature in icebox compartment 160. For example, the predetermined range or threshold may be an absolute value of a contemporary temperature. Alternatively, the predetermined range or threshold could be of a value of degrees or seconds at which a contemporary temperature is below a set point value, e.g., 32° Fahrenheit. Activation or speed of the air handler 192 and/or compressor 182 is at least partially based on the temperature within icebox compartment 160. Controller 194 is configured to receive a temperature signal from temperature sensor 196. In some such embodiments, temperature sensor 196 is a suitable electrical thermistor or thermocouple disposed within icebox compartment 160. According to the received temperature signal, controller 194 is configured to determine a contemporary temperature. A contemporary temperature within icebox compartment 160 that is below the predetermined range or threshold may be indicative of a beverage consistency that is inadequately frozen. A contemporary temperature that is below the predetermined range or threshold may be indicative of a beverage consistency that is excessively frozen or has reached a desired state or consistency. Based upon the determined contemporary temperature, rotation of air handler 192 may be increased, decreased, or maintained. Compressor 182 (see FIG. 3) may be additionally or alternatively activated. Optionally, a new target speed for air handler 192 may be selected by controller 194 before being transmitted to air handler 192. The target speed may be determined according to, e.g., a predetermined look-up table, formula, or model.

According to the contemporary temperature within icebox compartment 160, a visual and/or audio alert may be initiated, e.g., at control panel 148. For instance, controller 194 may be configured to determine or approximate the current state of beverage consistency. Determination may be made by reading or comparing a temperature signal received from temperature sensor 196. Contemporary temperature may be matched to a corresponding set point provided by, e.g., a predetermined look-up table, formula, or model. The visual and/or audio alert may include any suitable indication alert, such as an illuminated light, a predetermined noise projected from a speaker, or a message presented on an electronic display. As an example, controller 194 may initiate an alert via an alert signal transmitted to an illuminated LED on control panel 148. The signal transmission may occur once controller 194 has determined a desired beverage consistency has been reached according to the contemporary temperature within icebox compartment 160.

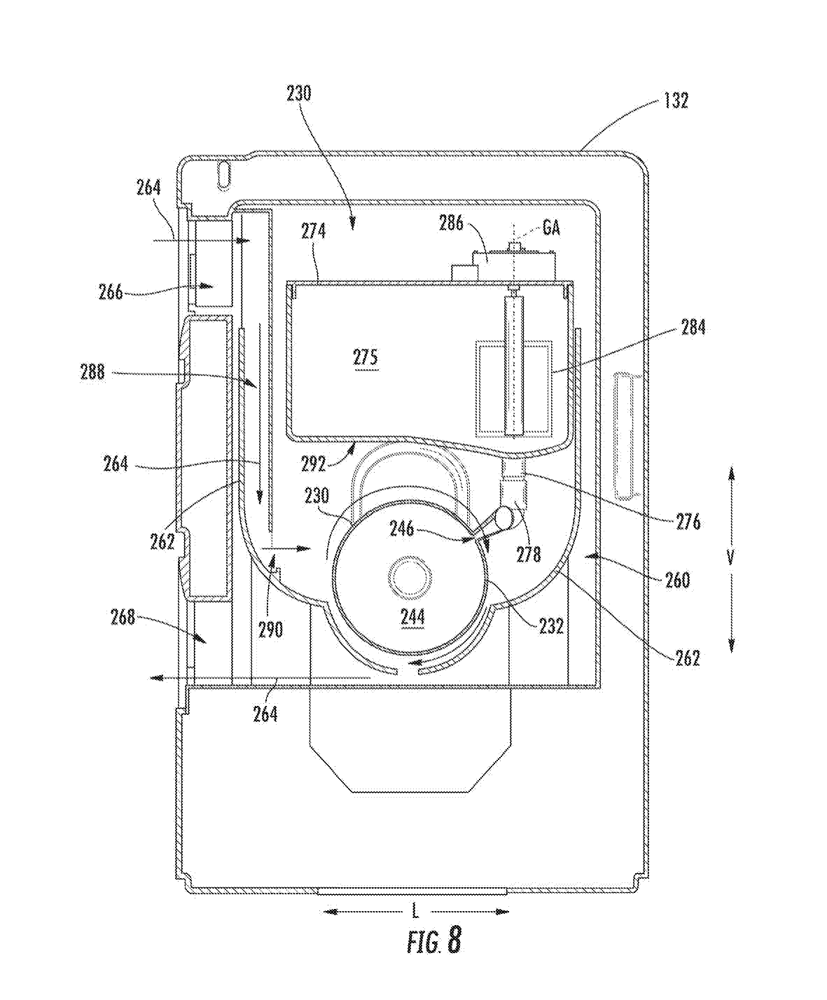

Turning to FIGS. 7 and 8, another exemplary embodiment of a frozen beverage unit 230 is illustrated. Generally, it is understood that the embodiment of FIGS. 7 and 8 is substantially identical to the embodiment of FIGS. 5 and 6, except as otherwise indicated. In addition, it should be noted that all or some of the elements of the exemplary embodiment of FIGS. 7 and 8 may be incorporated into the embodiment of FIGS. 5 and 6, as well as other additional or alternative embodiments.

In exemplary embodiments, such as the embodiment of FIGS. 7 and 8, frozen beverage unit 230 includes a liquid tank 274. Generally, liquid tank 274 defines a discrete liquid volume 275 for storing a liquid, such as one or more liquid ingredients (e.g., water, alcohol, sugar solutions, etc.) of a frozen beverage mixture. A shown, liquid tank 274 is provided in fluid communication with freezing tank 232. For instance, an intermediate conduit 276 may be provided between the liquid tank 274 and the freezing tank 232. In some embodiments, the intermediate conduit directs the liquid from the liquid volume 275 to the enclosed volume 244.

During operation of frozen beverage unit 230, liquid ingredients may be selectively supplied to the freezing tank 232 through liquid inlet 246, e.g., after an amount of frozen beverage mixture is dispensed through beverage outlet 248. Optionally, one or more release valve 278 may be provided in fluid communication between liquid tank 274 and freezing tank 232, e.g., within intermediate conduit 276. Release valve 278 may include a handle 282 disposed through air circulation housing 260 to be manually rotated, e.g., by a user, without removing the freezing tank 232 and/or air circulation housing 260.

In some embodiments, a liquid agitator or paddle 284 may be disposed within liquid tank 274. During operation, liquid agitator 284 may rotate about an agitator axis GA such that liquid within the tank is agitated or stirred. An agitating motor 286 may be operably attached to liquid agitator 284 to rotate or motivate liquid agitator 284 about the agitator axis GA. In some embodiments, agitating motor 286 is an electrical motor that is operable to constantly rotate liquid agitator 284 at one or more predetermined rotating speed when activated. Controller 194 or another discrete input mechanism (e.g., a button or switch positioned outside of liquid volume 275) may control activation of agitating motor 286. Optionally, an internal power source, such as a direct current battery, may be included with agitating motor 286 and/or within icebox compartment 160. Alternatively, one or more electrical connector may extend from agitating motor 286, e.g., through liner 132, and operably connect agitating motor 286 to an external power source, such as a residential power grid.

In exemplary embodiments, housing walls 262 of air circulation housing 260 at least partially enclosing freezing tank 232. Housing walls 262 define an air flow path (illustrated at arrows 264) about the outer surface 239 of the freezing tank 232. Air flow path 264 will generally extend between chilled air inlet 266 and chilled air outlet 268. In some embodiments, chilled air inlet 266 is defined through housing wall 262 above chilled air outlet 268, e.g., in the vertical direction V. Optionally, chilled air outlet 268 is defined below freezing tank 232 while chilled air inlet 266 is a position above freezing tank 232.

As illustrated, air flow path 264 may be defined to substantially bypass liquid tank 274. For instance, an internal duct 288 may be formed within air circulation housing 260. In some such embodiments, internal duct 288 extends in the vertical direction V between chilled air inlet 266 and chilled air outlet 268. As shown, internal duct 288 may extend in fluid communication from chilled air inlet 266 and define a duct aperture 290. During operation, internal duct 288 may isolate liquid tank 274 from the air flow path 264, e.g., between chilled air inlet 266 and duct aperture 290. As shown, duct aperture 290 may be defined below liquid tank 274 such that chilled air exits internal duct 288 below liquid tank 274. In some such embodiments, liquid tank 274 extends in the lateral direction L across a portion of air circulation housing 260. A bottom portion 292 of liquid tank 274 may block airflow, e.g., in the vertical direction V, further defining air flow path 264 and preventing chilled air from passing across the remainder of liquid tank 274. From the duct aperture 290 of internal duct 288, chilled air may flow across freezing tank 232 before being direct be directed outside of air circulation housing 260 from chilled air outlet 268. As shown, chilled air outlet 268 may be defined through housing wall 262 at a position below chilled air inlet 266 and/or internal duct 288.

Turning now to FIG. 9, a flow diagram is provided of a method 300 according to an exemplary embodiment of the present disclosure. Generally, the method 300 provides for a method of operating a refrigeration appliance 100 (see FIG. 1) that includes a cabinet, door, icebox compartment, icemaker, and ice crusher motor, as described above. The method 300 can be performed, for instance, by the controller 194 (see FIG. 3). For example, controller 194 may, as discussed, be operably connected to ice crusher motor 224, compressor 182, and/or air handler 192, and may send signal to and receive signal from ice crusher motor 224, compressor 182, air handler 192, control panel 148, and sensors 196, 198 (see FIG. 3). Controller 194 may further be in communication with other suitable components of the appliance 100 to facilitate operation of the appliance 100 generally. FIG. 9 depicts steps performed in a particular order for purpose of illustration and discussion. Those of ordinary skill in the art, using the disclosures provided herein, will understand that the steps of any of the methods disclosed herein can be modified, adapted, rearranged, omitted, or expanded in various ways without deviating from the scope of the present disclosure.

Referring to FIG. 9, at 310, the method 300 includes detecting a frozen beverage unit including a freezing tank and a rotatable auger in operable attachment with the ice crusher motor. For instance, 310 may include receiving a detection signal from a proximity sensor, as described above. The detection signal may be received in response to a prong of the frozen beverage unit engaging the proximity sensor. In further embodiments, the detection signal may be received in response to the prong directly contacting the proximity sensor.

At 320, the method 300 includes preventing icemaker operation based on detection of the frozen beverage unit. In some embodiments, controller may halt signals to the icemaker. As noted above, some embodiments of appliance include a valve in fluid connection with icemaker for regulating a flow of liquid water to icemaker. In some such embodiments, 320 may include positioning valve in a closed configuration and restricting the flow of water to the icemaker.

At 330, the method includes activating the ice crusher motor to rotate the auger based on detection of the frozen beverage unit. Activation of ice crusher motor may continue for a predetermined time period or open-ended time period. In optional embodiments, input signals from an actuating mechanism for an ice dispenser are decoupled from ice crush motor. For instance, the controller may disregard or override any such signals during activation of the ice crusher motor.

In some embodiments, activation of the air handler is based on additional or alternative conditions to detection of the frozen beverage unit. For instance in some embodiments, activation is further based on determination of an air flow condition. In such embodiments, method 300 includes determining an air flow condition associated with the frozen beverage unit. Activating the air handler may be controlled according to the determination. In optional embodiments, determining an air flow condition includes determining a contemporary rotating speed of the auger. If rotating speed of the auger is determined to be above or below a predetermined range or threshold, rotation of the air handler may be increased or decreased accordingly. In additional or alternative embodiments, determining an air flow condition includes determining a contemporary temperature within the icebox compartment. If the contemporary temperature is determined to be above or below a predetermined range or threshold, rotation of the air handler may be increased or decreased accordingly. Optionally, activation of air handler may include activating a compressor to cool air being directed to and from air handler.

In some embodiments, the method 300 further includes determining a desired state. For instance, determination of a desired state may be made based on input signals received from ice crusher motor and/or temperature sensor, as discussed above. Once a desired state is determined, an alert signal may be transmitted. For instance, alert signal may be transmitted to a control panel to initiate a visual and/or audio alert.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance comprising:
a cabinet defining a chilled chamber;
a door attached to the cabinet to selectively restrict access to the chilled chamber, the door comprising a door liner defining an icebox compartment;
a sealed cooling system in fluid communication with the icebox compartment to circulate air within the refrigerator appliance;
an ice crusher motor mounted within the icebox compartment; and
a frozen beverage unit comprising a freezing tank and a rotatable auger, the rotatable auger extending into the freezing tank and in operable attachment with the ice crusher motor.

2. The appliance of claim 1, wherein the frozen beverage unit further comprises an air circulation housing at least partially enclosing the freezing tank, wherein the air circulation housing defines an air flow path about the outer surface of the freezing tank.

3. The appliance of claim 1, wherein the frozen beverage unit further comprises a liquid tank in fluid communication with the freezing tank to selectively supply a liquid to the freezing tank.

4. The appliance of claim 1, further comprising:
an icemaker mounted within the icebox compartment above the ice crusher motor, the icemaker including an ejector arm and an ejector motor operably attached to the ejector arm to motivate rotation thereof.

5. The appliance of claim 1, wherein the frozen beverage unit further comprises a gearbox operably attaching the ice crusher motor to the rotatable auger.

6. The appliance of claim 1, further comprising:
a controller operably connected to the ice crusher motor and configured to control operation of the ice crusher motor according to a predetermined frozen beverage mode.

7. The appliance of claim 6, further comprising:
a proximity sensor disposed in selective engagement with the frozen beverage unit, wherein the controller is operably connected to the proximity sensor to receive a detection signal therefrom, and wherein the controller is further configured to initiate the predetermined frozen beverage mode based on receiving the detection signal.

8. The appliance of claim 7, wherein the sealed cooling system comprises an air handler in fluid communication with the icebox compartment, and wherein initiating the predetermined frozen beverage mode comprises activating rotation of the air handler.

9. The appliance of 1, wherein the frozen beverage unit is selectively removable from the icebox compartment, and wherein the refrigerator appliance further comprises:
a rotatable ice crusher blade selectively mountable within icebox compartment in operable attachment with the ice crusher motor.

10. A refrigerator appliance comprising:
a cabinet defining a chilled chamber;
a door attached to the cabinet to selectively restrict access to the chilled chamber;
a liner defining an icebox compartment within the cabinet;
a sealed cooling system comprising a chilled air supply duct and a chilled air return duct, the chilled air supply duct and the chilled air return duct being in fluid communication with the icebox compartment; and
a frozen beverage unit disposed within the icebox compartment, the frozen beverage unit comprising
an air circulation housing defining a chilled air inlet in downstream fluid communication with the chilled air supply duct, and a chilled air outlet in upstream fluid communication with the chilled air return duct, the air circulation housing further defining an air flow path between the chilled air inlet and the chilled air outlet,
a freezing tank disposed within the air flow path of the air circulation housing, and
a rotatable auger extending through the freezing tank.

11. The appliance of claim 10, wherein the frozen beverage unit comprises a liquid tank in fluid communication with the freezing tank to selectively supply a liquid to the freezing tank.

12. The appliance of 11, wherein the air circulation unit comprises an internal duct isolating a portion of the liquid tank from the air flow path.

13. The appliance of 10, wherein the frozen beverage unit further comprises a gearbox operably attaching the motor to the rotatable auger.

14. The appliance of 10, further comprising:
a controller operably connected to the motor and configured to control operation of the motor according to a predetermined frozen beverage mode.

15. The appliance of claim 14, further comprising:
a proximity sensor disposed in selective engagement with the frozen beverage unit, wherein the controller is operably connected to the proximity sensor to receive a detection signal therefrom, and wherein the controller is further configured to initiate the predetermined frozen beverage mode based, at least in part, on receiving the detection signal.

16. The appliance of claim 15, wherein the sealed cooling system comprises
an air handler in fluid communication with the chilled air supply duct and the chilled air return duct, and wherein initiating the predetermined frozen beverage mode comprises activating rotation of the air handler.

17. A method of operating a refrigerator appliance, the appliance comprising a cabinet and a door attached to the cabinet, the appliance defining an icebox compartment and further comprising an icemaker and an ice crusher motor mounted within the icebox compartment, the method comprising:
detecting a frozen beverage unit including a freezing tank and a rotatable auger in operable attachment with the ice crusher motor;
preventing icemaker operation based on detection of the frozen beverage unit; and
activating the ice crusher motor to rotate the auger based on detection of the frozen beverage unit.

18. The method of claim 17, further comprising:
determining an air flow condition associated with the frozen beverage unit; and
activating an air handler based on the determination of the air flow condition.

19. The method of claim 18, wherein determining the air flow condition comprises determining a contemporary rotating speed of the auger.

20. The method of claim 19, wherein determining the air flow condition further comprises determining a contemporary temperature within the icebox compartment.
